(19) United States
(12) Patent Application Publication
(10) Pub. No.: US 2015/0144039 A1
(43) Pub. Date: May 28, 2015

(54) ANHYDROUS AMMONIA INJECTOR FOR DISK OPENER

(71) Applicant: Morris Industries Ltd., Saskatoon (CA)

(72) Inventors: Mark R. Benko, Willowbrook (CA); Clint W. Sheppard, Yorkton (CA); Garth W. Massie, Biggar (CA)

(73) Assignee: Morris Industries Ltd., Saskatoon (CA)

(21) Appl. No.: 14/550,502

(22) Filed: Nov. 21, 2014

Related U.S. Application Data
(60) Provisional application No. 61/908,330, filed on Nov. 25, 2013.

(51) Int. Cl. A01C 23/02; A01B 49/06

(52) U.S. Cl. CPC A01C 23/024; A01B 49/06
USPC 111/119

(57) ABSTRACT

A disk opener includes a disk blade for creating a furrow and a closing wheel for closing it. An injection zone is defined generally below and up to slightly forward of the closing wheel. An anhydrous ammonia injector is mounted between the blade and the wheel and delivers anhydrous ammonia via a delivery tube into the furrow at an injection point within the injection zone. The injection point is also preferably centered within the furrow.

### RELATED APPLICATIONS

The present non-provisional patent application claims priority benefit of earlier-filed provisional patent application Ser. No. 61/908,330, filed Nov. 25, 2013, entitled NH3 INJECTOR FOR DISK OPENER, which is hereby incorporated by reference into the present application in its entirety.

### FIELD

The present invention relates to the field of agricultural implements and, more particularly, to systems and methods for delivering treatments into furrows.

### BACKGROUND

Since its discovery as a useful nutrient for crop plants, anhydrous ammonia has been widely employed in agriculture as a source of fertilizer for growing crops Anhydrous ammonia is a clear gas at normal temperatures and pressures, which makes it difficult to place into the soil where crop plants can access it. More specifically, it is stored under pressure and injected into the soil as a liquid, but quickly begins to evaporate as a gas into the atmosphere. Thus, farmers and agricultural engineers have worked for many years to more efficiently apply anhydrous ammonia so that more of it is retained in the soil for use by plants. With increases in operating costs for fuel, wages, and equipment, farmers have been adopting practices that require less tillage, which increases the importance of capturing as much anhydrous ammonia as possible under conditions of minimal tillage and soil disturbance.

A disk opener employs a circular disk blade at a low four (4) to ten (10) degree angle with respect to the direction of travel to create a furrow in the soil. The disk opener results in very little soil movement, which allows for higher ground speed and increased productivity but also makes it more difficult to efficiently apply anhydrous ammonia. In particular, higher ground speed and lower soil disturbance increases the difficulty of getting the anhydrous ammonia to mix with the soil without gassing off. Agricultural operations are being driven toward higher levels of cost efficiency and risk management due to narrower profit margins and higher input costs (e.g., seeds, fertilizer, chemicals). For this reason, it is desirable to dispense in a single-pass operation both seeds and fertilizer or other treatment relevant to the successful development or growth of the seeds in order to reduce fuel costs and minimize wear on machinery and equipment. However, combining these operations requires managing certain risks. On the one hand, dispensing too much fertilizer can result in “seed burn” or fertilizer toxicity which can increase seedling mortality. This can occur when the concentration of fertilizer (which usually contains a combination of nitrogen, phosphorus, potassium, and sulfur) near the seed is too high and poisons the seed, which prevents germination and growth. On the other hand, dispensing too little fertilizer can also lead to the loss of valuable production capacity due to a lack of nutrients available to the growing plants.

This background discussion is intended to provide information related to the present invention which is not necessarily prior art.

### SUMMARY

Embodiments of the present invention solve the above-described and other problems and limitations by providing a disk opener configured to open and close a furrow in soil during agricultural operations, with the opener including an improved anhydrous ammonia injector for delivering anhydrous ammonia into the furrow in such a manner as to minimize the amount of anhydrous ammonia that is lost to the atmosphere.

According to an aspect of the present invention, the disk opener includes a rotatable disk blade configured to create a furrow in the soil as the disk blade is moved in a direction of travel. The opener also includes a rotatable wheel located behind the disk blade with respect to the direction of travel and configured to close the furrow. The closing wheel presents foremost and rearmost portions relative to the direction travel. The closing wheel is configured to engage the soil and thereby define an underlying injection zone in the soil, wherein the injection zone extends from a rearwardmost margin that substantially corresponds to the rearmost portion of the closing wheel and a forwardmost margin that is approximately between two and four inches in front of the foremost portion of the closing wheel. The opener further includes an anhydrous ammonia injector configured to deliver anhydrous ammonia into the furrow at an injection point within the injection zone.

This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### DRAWINGS

Preferred embodiments of the present invention are described in detail below with reference to the attached drawing figures, wherein:

FIG. 1 is a fragmentary left side elevation view of a first embodiment of a disk opener including an anhydrous ammonia injector constructed in accordance with the principles of the present invention;

FIG. 2 is a left-front isometric view of the disk opener of FIG. 1;

FIG. 3 is a right-front isometric view of the disk opener of FIG. 1, with the gauge wheel being removed to show the anhydrous ammonia injector;

FIG. 4 is a left side elevation view of the anhydrous injector of the disk opener of FIG. 1;

FIG. 5 is an enlarged fragmentary rear elevation view of the disk opener of FIG. 1, particularly showing the location of the injector point of the anhydrous ammonia injector relative to the disk blade, the gauge wheel, and the closing wheel;

FIG. 6 is a fragmentary cross-sectional rear elevation view of a furrow created by the disk opener of FIG. 1;

FIG. 7 is a right side elevation view of a second embodiment of the disk opener constructed in accordance with the principles of the present invention;

FIG. 8 is a fragmentary left-rear isometric view of the disk opener of FIG. 7, with the closing wheel being removed to particularly show the anhydrous ammonia injector;

FIG. 9 is a left-front isometric view of the disk opener of FIG. 7; and

FIG. 10 is a fragmentary left-rear isometric view of the anhydrous ammonia injector component of the disk opener of FIG. 7.

The drawing figures do not limit the present invention to the specific embodiments disclosed and described herein. The drawings are not necessarily to scale, emphasis instead being placed upon clearly illustrating the principles of the preferred embodiments.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

Broadly characterized, during agricultural operations in which a disk opener opens and closes a furrow in soil, the present invention provides an improved anhydrous ammonia injector for delivering anhydrous ammonia into the furrow in such a manner as to minimize the amount of anhydrous ammonia that is lost to the atmosphere.

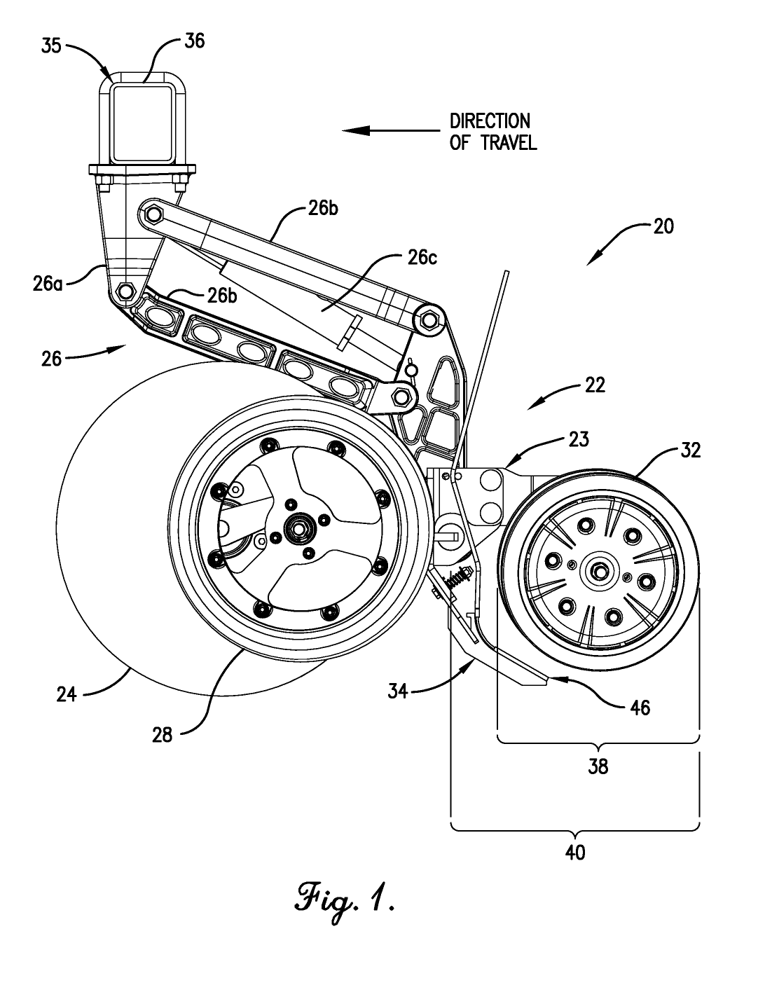

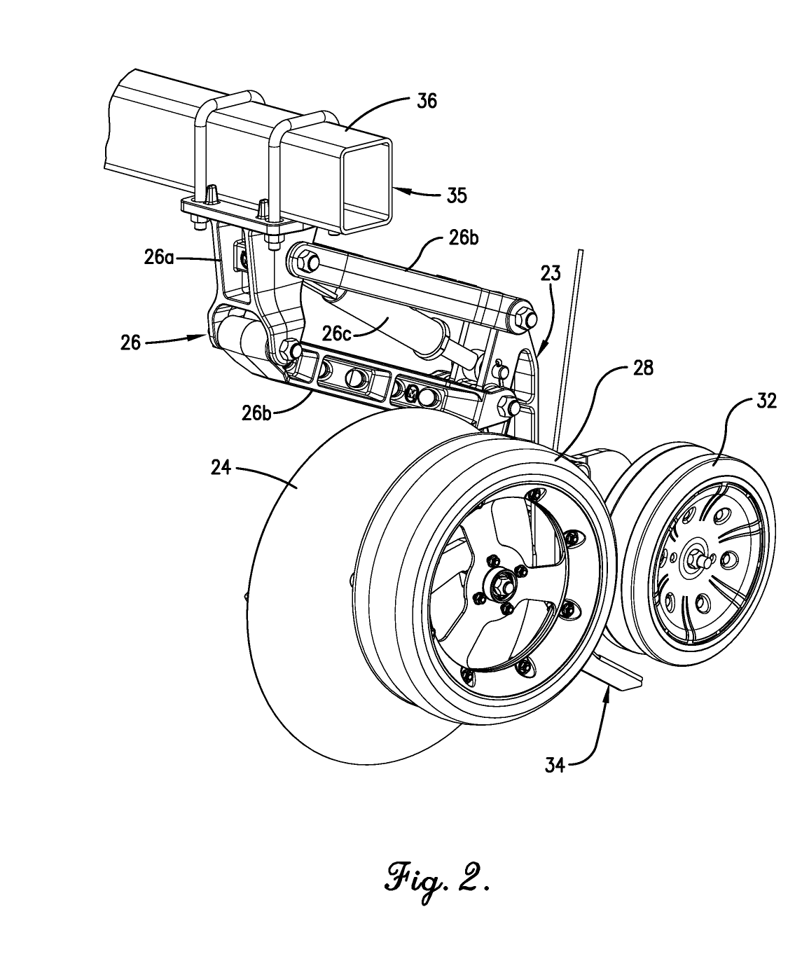

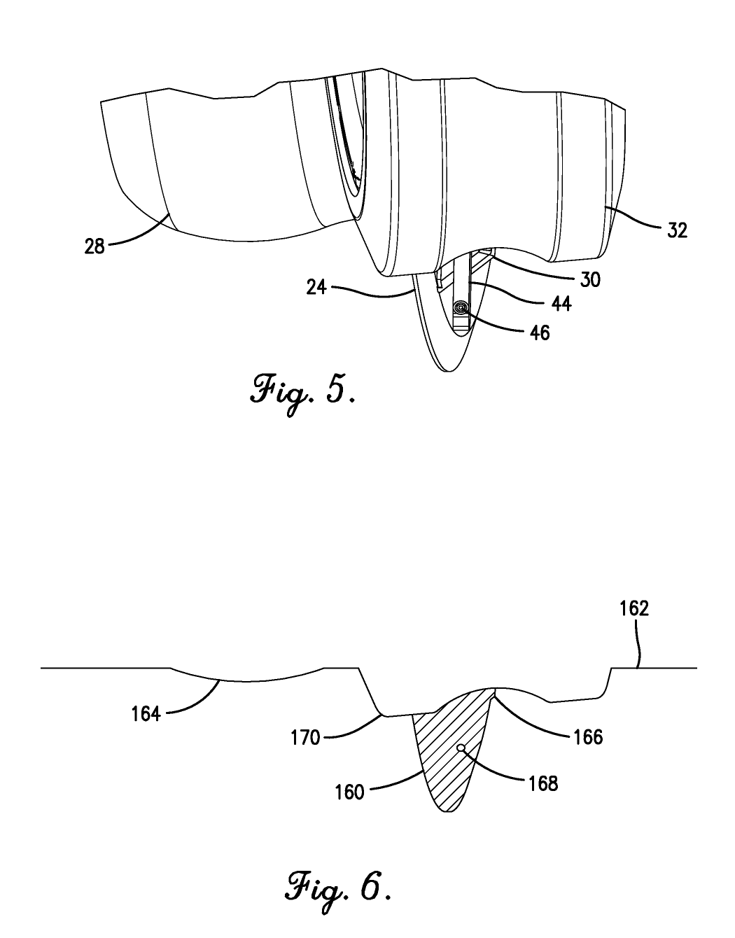

Referring to FIGS. 1-6, a first embodiment of an exemplary disk opener 20 may broadly comprise an assembly 22 operable to create a furrow in the soil as the assembly is moved in the direction of travel (see FIG. 1) and deposit anhydrous ammonia in the soil. The assembly generally includes a frame 23, a disk blade 24, an opener linkage 26, a gauge wheel 28, a seed boot 30, and a closing wheel 32. Moreover, the assembly 22 is provided with an anhydrous ammonia injector 34. Typically, the disk opener 20 will be one of a plurality of such disk openers coupled with an agricultural implement 35. As is customary, the implement 35 includes a laterally extending toolbar 36 along which multiple openers (only one being shown) are spaced.

In one implementation, the assembly 22 may take the form of the assembly disclosed in published patent application document 2008/0093093 (the '093 publication), filed Oct. 22, 2007, and titled “Combination Hydraulic Hold-Down and Lift System for an Agricultural Implement,” which is hereby incorporated by reference in its entirety into the present specification as a description of an exemplary implementation of the assembly 22.

The frame 23 includes a number of frame components on which the disk blade 24, gauge wheel 28, seed boot 30, closing wheel 32, and injector 34 are supported. The frame 23 is coupled to the toolbar 36 by the linkage 26. The linkage 26 includes a toolbar connector 26a secured to the toolbar 36. A pair of links 26b extend between the connector 26a and frame 23. Preferably, the frame 23 and linkage 26 cooperatively form a parallelogram linkage. The opener linkage 26 moveably couples the other assembly components to the tool bar 36 of the agricultural implement in such a manner as to allow the components to float free of the tool bar 36 and follow the contour of the surface of the soil. In the preferred embodiment, the linkage 26 includes a hydraulic cylinder 26c (or other suitable spring component, such as a helical spring) to provide a biasing force to yieldably urge the opener components (such as the disk blade 24, gauge wheel 28, seed boot 30, closing wheel 32, and injector 34) into engagement with the soil. The opener may be provided with alternative structure for supporting the various opener components on the toolbar 36, without departing from the spirit of the present invention. For example, a spring-loaded rockshaft (not shown) may be provided instead of the linkage 26 for coupling the frame 23 to the toolbar 36.

The disk blade 24 may be a substantially circular disk rotatably mounted and configured to move through the soil in a direction of travel at an angle of approximately between four (4) and ten (10) degrees in order to create the furrow in the soil. The illustrated disk blade 24 preferably presents a generally flat configuration with a tapered circumferential edge having a smooth, circular shape. However, the principles of the present invention are equally applicable to alternative blade designs. For example, the disk blade may alternatively have a corrugated or generally concave shape or have an outer circumference that is toothed or otherwise segmented, without departing from the spirit of the present invention.

The preferred gauge wheel 28 is a substantially circular wheel rotatably mounted and configured to control the depth of the furrow created by the disk blade 24. More specifically, the gauge wheel 28 may ride over the surface of the soil while the disk blade 24 cuts through the soil, and the differential distance between the lowest point of the gauge wheel 28 and the lowest point of the disk blade 24 determines the depth of the furrow.

The seed boot 30 may include one or more internal passages configured to deliver seeds and/or granular fertilizer and/or other solid, liquid, or gaseous treatments into the furrow. If desired, the seed boot 30 may utilize any suitable configuration or be eliminated altogether.

The preferred closing wheel 32 is a substantially circular wheel rotatably mounted behind the disk blade 24 and configured to close the furrow and substantially seal the seeds and/or treatment(s), including the anhydrous ammonia, in the soil. The diameter of the closing wheel 32 may define a “wheel shadow” 38 beneath the closing wheel 32. More specifically, the wheel shadow 38 may extend approximately between a point on the soil that substantially corresponds to the rearmost portion of the closing wheel 32 and another point on the soil that substantially corresponds to a foremost portion of the closing wheel 32.

It has been determined that the closing wheel 32 also advantageously defines an “injection zone” 40, for purposes which will subsequently be described. The injection zone 40 preferably extends approximately between the rearmost portion of the wheel shadow 38 and approximately between two (2) inches and four (4) inches, or more preferably approximately three (3) inches, in front of the foremost portion of the wheel shadow 38. More specifically, the injection zone 40 may extend approximately between a first point on the soil that substantially corresponds to the rearmost portion of the closing wheel/wheel shadow and second point on the soil that is approximately between two (2) and four (4) inches, or more preferably three (3) inches, in front of a foremost portion of the closing wheel/wheel shadow.

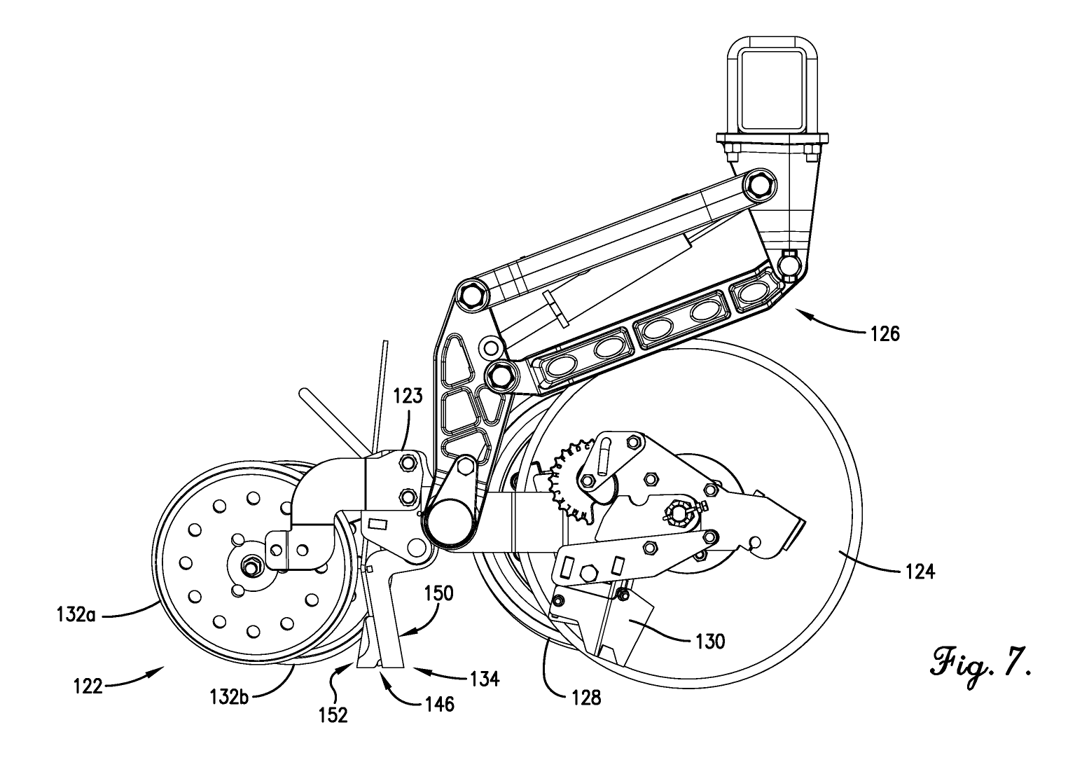

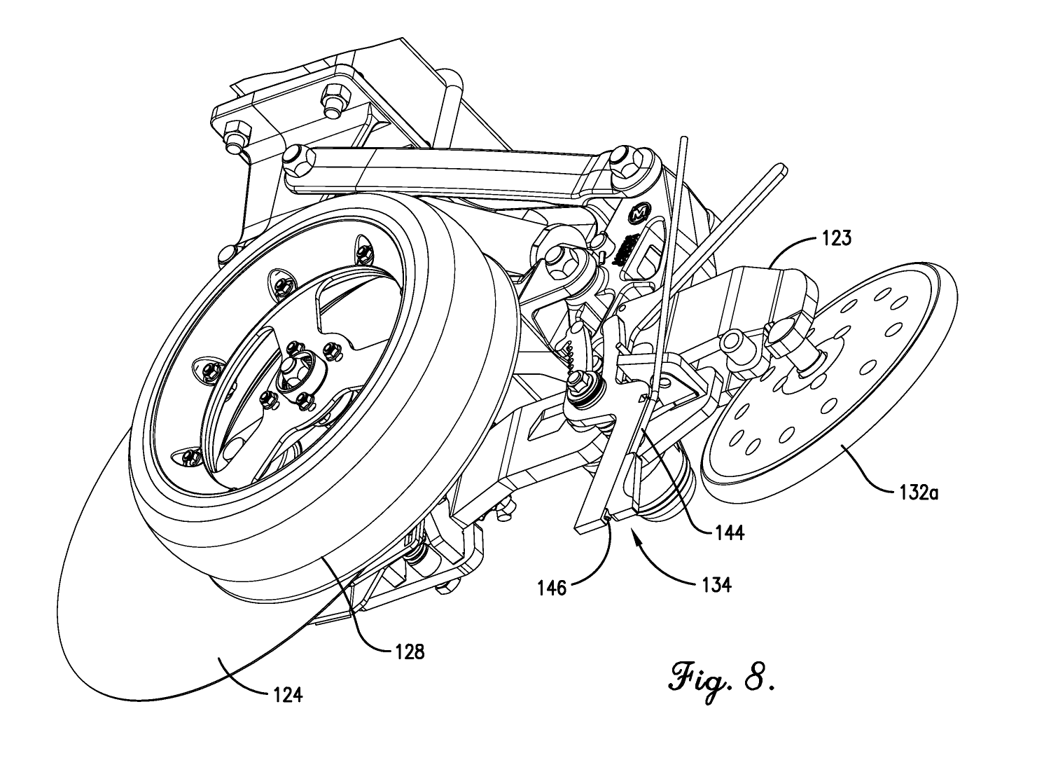

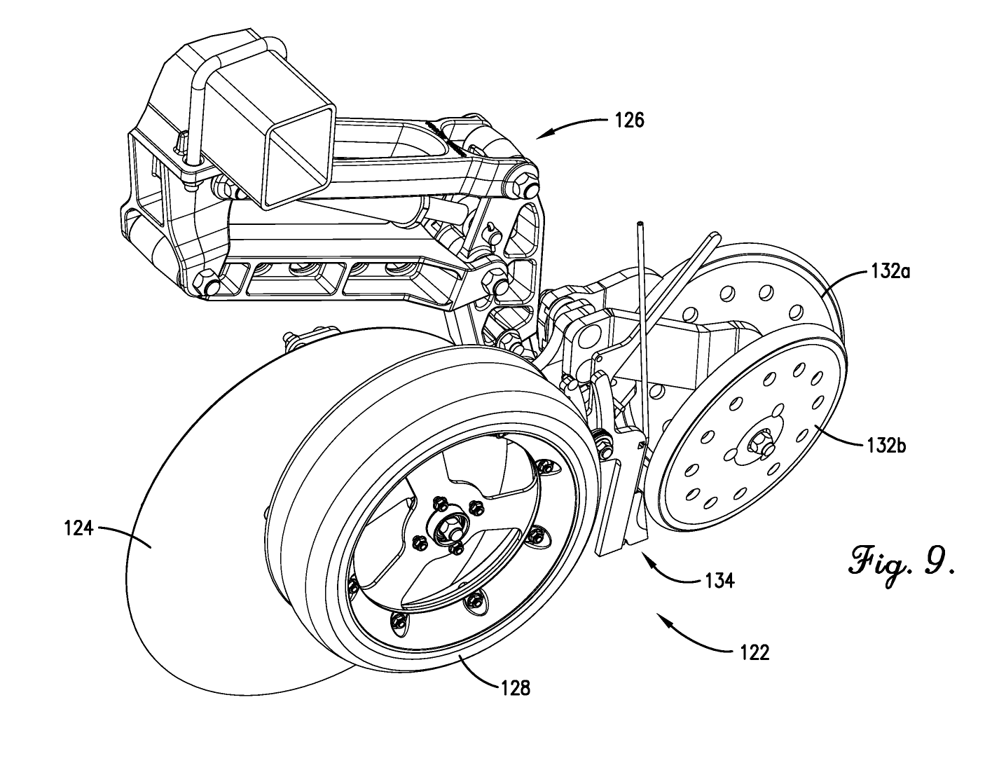

As shown in FIGS. 1-6, the first embodiment of the assembly 22 is preferably provided with a single closing wheel 32. However, as shown in FIGS. 7-10 with respect to a second embodiment of the assembly 22, the assembly 22 may alternatively be provided with two (2) closing wheels 132a, 132b (or more). In the second embodiment, the first closing wheel 132a is in a leading position and oriented at a positive first angle, and the second wheel 132b is in a trailing position and oriented at a negative second angle which may be the negative complement of the first angle. The second embodiment may be otherwise substantially similar or identical to the first embodiment with regard to the disk blade 124, the opener linkage 126, the gauge wheel 128, and the seed boot 130.

Additional or alternative components such as a firmer wheel (not shown), a toothed closing wheel (not shown), and/or a row cleaner (not shown) may be included in the disk opener 20 to assist in clearing debris or placing seeds or treatments.

The anhydrous ammonia injector 34 is preferably mounted to the frame 23 between the disk blade 24 and the closing wheel 32, although other mounting positions and configurations are within the ambit of the present invention. The injector 32 is preferably configured to deliver anhydrous ammonia via a delivery tube 44, through an outlet 46 of the tube 44, into the furrow. More specifically, the injector 34 may be configured to apply the anhydrous ammonia at an injection point (defined by the outlet 46) which is within the injection zone 40. Even more preferably, the injector 34 is configured so that the injection point is centered in the furrow (in a direction that is at least substantially transverse to the direction of travel). If desired, the injector 34 may be provided with other suitable means for delivering the anhydrous ammonia to the soil. For example, the anhydrous ammonia injector may alternatively include an internal passageway leading to the injection point (rather than a separate tube). Additionally, an alternative injector might have an injection body that defines the injection point (rather than relying on the outlet of the tube).

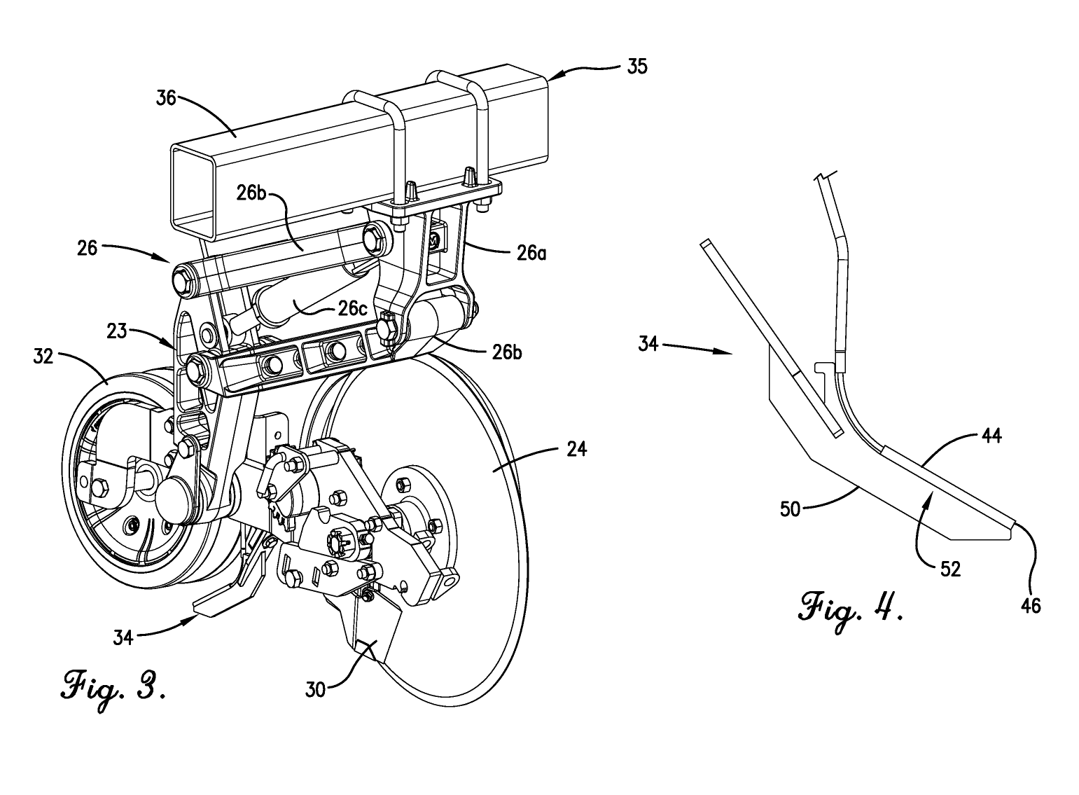

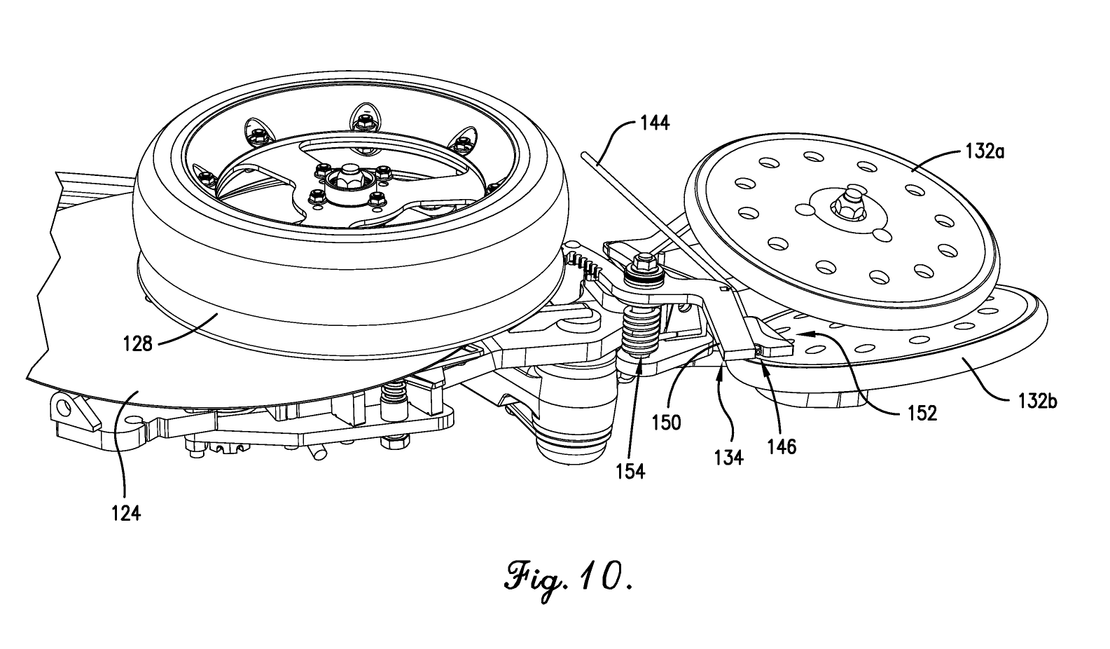

In a first implementation best seen in FIG. 4, a forward side 50 of the injector 34 preferably has a relatively low rake angle of at most approximately forty-five (45) degrees, which both allows the injector 34 to ride over obstacles (e.g., rocks) that may appear between the disk blade 24 and the injector 34 and allows the injector 34 to follow the bottom of the furrow without aggressively engaging the soil. The delivery tube 44 through which the anhydrous ammonia travels may extend down a rearward side 52 of the injector 34. Thus, the anhydrous ammonia may be injected from the outlet 46 of the delivery tube 44 at a lower rearward area of the injector 34 and at a downward and rearward angle, which allows the anhydrous ammonia to be delivered without other components of the disk opener 20 disturbing its placement. In a second implementation best seen in FIG. 10, the forward side 150 of the injector 134 preferably has a relatively higher rake angle of at least approximately forty-five (45) degrees, and the delivery tube 144 may extend down an intermediate portion of the injector 134 such that its outlet 146 is located between the forward and rearward sides 150, 152 sides of the injector 134. Under some operating conditions, the higher rake angle may lead to improved flow of the injector 134 through soil or obstacles, and the intermediate injection point may decrease wear and extend the working life of the injector 134.

The injector 34 is preferably mounted to the frame 23 in such a manner as to allow for adjusting the position of the injector, especially with regard to adjusting the depth of the injection point within the furrow. Although not shown in detail, the injector 34 is preferably fastened to the frame 23, with the frame 23 and/or injector 34 including an oversized (e.g., slotted) opening to permit vertical repositioning of the injector 34 relative to the frame 23. Furthermore, the injector 34 is preferably mounted to the frame 23 in such a manner as to allow for sideward movement of the injector 34 to the left or right relative to the direction of travel so as to remain in the furrow when the disk opener 20 moves left or right around corners or curves. Such limited sideward movement of the injector 34 relative to the frame 23 is accomplished in any suitable manner. For example, the connection of the injector 34 to the frame 23 can be accomplished with yieldable “clamping” (provided, for instance, by compressible washers, helical spring, etc.) that permits the injector 34 to shift side-to-side relative to the frame 23 against the yieldable bias, while preventing relative movement along a fore-and-aft plane. Additionally, in one implementation best seen in FIG. 10, an alternative assembly 122 involves pivotably mounting the injector 134 to the frame 123. The assembly includes a biasing element 154 (preferably in the form of a torsion spring, although other suitable biasing elements (e.g., a hydraulic cylinder, helical spring, etc.) may be used) that yieldably urges the injector 134 to a forward position. When the injector 134 encounters an obstacle (e.g., a rock) that exerts sufficient force to overcome the forward biasing force of the spring or torsion element 154, the injector 134 pivots rearwardly, or “trips,” to avoid damage and then returns to the forward position once the obstacle has passed. In another implementation, the disk opener 20 or various components thereof may be configured to trip as a unit, and the injector 34 may trip with but not independently of them.

In operation, the disk opener 20 may function substantially as follows. Referring particularly to FIG. 6, as the disk opener 20 is moved over the soil, the disk blade 24 creates the furrow 160 in the soil as the gauge wheel 28 rides over the surface 162 of the soil (possibly leaving an impression 164, depending on soil conditions) and determines the depth of the furrow 160. Seeds and possibly one or more treatments (e.g., granular fertilizer) are delivered via the seed boot 30 into the furrow (which may also leave an impression 166, depending on the design of the seed boot). Liquid anhydrous ammonia is delivered via the delivery tube 44 into the furrow at the injection point 168 which is within the injection zone 40 and substantially centered in the furrow 160. As described, the injection zone 40 is defined relative to the closing wheel 32 and its wheel shadow. Before a substantial amount of the anhydrous ammonia can evaporate into a gas and escape into the atmosphere, the closing wheel 32 closes the furrow 160 (possibly leaving an impression 170) and thereby traps the anhydrous ammonia in the soil where it can be used by the plants.

Thus, it will be appreciated that the present invention provides several advantages over the prior art. In particular, the improved anhydrous ammonia injector 34 delivers the anhydrous ammonia into the furrow 160 in such a manner as to minimize the amount of anhydrous ammonia that is lost to the atmosphere. In particular, prior art systems inject the anhydrous ammonia at the seed boot, which allows more of it to evaporate as a gas and be lost to the atmosphere before the furrow is closed. The present invention injects the anhydrous ammonia in the injection zone 40 under the closing wheel 32 so that more of it is retained in the soil for use by the plants. Furthermore, injecting the anhydrous ammonia at the seed boot increases the risk that the gaseous treatment will flow back into the seed boot or be blown out of the furrow when a granular fertilizer or other treatment is pneumatically delivered via the seed boot into the furrow. The present invention separates the injection of the anhydrous ammonia from the pneumatic delivery of another treatment, while still allowing both to be delivered in a single pass operation, so that more of it is retained in the soil for use by the plants while still maintaining operational efficiency. Additionally, integrating the injector into the seed boot makes the position of the injector, especially with regard to the depth of the point of injection in the furrow, dependent on the position of the seed boot. The present invention separates the injector 34 from the seed boot 30 so that the depth of the point of injection 168 can be independently controlled based on operating conditions and any other treatments being applied in the same pass.

Additionally, injecting the anhydrous ammonia at the rearward side 52 of the injector 34 allows for operating in colder temperature. More specifically, when anhydrous ammonia is injected into the soil in a liquid state, it immediately begins evaporating to a gaseous state. As it evaporates to a gaseous state, it takes heat energy from its surroundings. Thus, the evaporation of the anhydrous ammonia could cause the soil to freeze to other components of the assembly 22. By injecting the anhydrous ammonia at the rear of the system, this effect occurs after the other components have passed, so the soil is less likely to freeze to them.

Although the invention has been described with reference to the one or more embodiments illustrated in the figures, it is understood that equivalents may be employed and substitutions made herein without departing from the scope of the invention as recited in the claims. That is, obvious modifications to the exemplary embodiments, as hereinabove set forth, could be readily made by those skilled in the art without departing from the spirit of the present invention.

Furthermore, the preferred forms of the invention described above are to be used as illustration only and should not be utilized in a limiting sense in interpreting the scope of the present invention.

The inventors hereby state their intent to rely on the Doctrine of Equivalents to determine and assess the reasonably fair scope of the present invention as pertains to any apparatus not materially departing from but outside the literal scope of the invention set forth in the following claims.

What is claimed is:

1. An agricultural disk opener comprising:
a rotatable disk blade configured to create a furrow in the soil as the disk blade is moved in a direction of travel;
a rotatable wheel located behind the disk blade with respect to the direction of travel and configured to close the furrow,
said closing wheel presenting foremost and rearmost portions relative to the direction travel,
said closing wheel being configured to engage the soil and thereby define an underlying injection zone in the soil, wherein the injection zone extends from a rearwardmost margin that substantially corresponds to the rearmost portion of the closing wheel and a forwardmost margin that is approximately between two and four inches in front of the foremost portion of the closing wheel; and
an anhydrous ammonia injector configured to deliver anhydrous ammonia into the furrow at an injection point within the injection zone.

2. The agricultural disk opener as claimed in claim 1,
said anhydrous ammonia injector presenting opposite forward and rearward sides relative to the direction of travel,
said anhydrous ammonia injector including an intermediate portion defined between the sides,
said injection point being located along the rearward side.

3. The agricultural disk opener as claimed in claim 1,
said anhydrous ammonia injector presenting a forward side relative to the direction of travel,
said forward side of the anhydrous ammonia injector having a rake angle of at most approximately 45 degrees.

4. The agricultural disk opener as claimed in claim 1,
said anhydrous ammonia injector presenting a forward side relative to the direction of travel,
said forward side of the anhydrous ammonia injector having a rake angle of at least approximately 45 degrees.

5. The agricultural disk opener as claimed in claim 1,
said anhydrous ammonia injector presenting a rearward side relative to the direction of travel,
said anhydrous ammonia injector including a delivery tube in communication with the injection point,
said delivery tube extending down the rearward side of the anhydrous ammonia injector.

6. The agricultural disk opener as claimed in claim 1,
said anhydrous ammonia injector presenting opposite forward and rearward sides relative to the direction of travel,
said anhydrous ammonia injector including an intermediate portion defined between the sides,
said anhydrous ammonia injector including a delivery tube in communication with the injection point,
said delivery tube extending down the intermediate portion of the anhydrous ammonia injector.

7. The agricultural disk opener as claimed in claim 1,
said anhydrous ammonia injector including a delivery tube in communication with the injection point,
said delivery tube defining the injection point.

8. The agricultural disk opener as claimed in claim 7,
said delivery tube being configured to deliver the anhydrous ammonia at a downward and rearward angle into the furrow.

9. The agricultural disk opener as claimed in claim 1, further including:
a frame supporting each of the disk blade and closing wheel for rotational movement.

10. The agricultural disk opener as claimed in claim 9,
said anhydrous ammonia injector being supported on the frame between the disk blade and the closing wheel.

11. The agricultural disk opener as claimed in claim 9,
said anhydrous ammonia injector being adjustably mounted to the frame to allow for adjusting a depth of the injection point in the furrow.

12. The agricultural disk opener as claimed in claim 9,
said anhydrous ammonia injector being moveably mounted to the frame to allow for limited sideward movement of the anhydrous ammonia injector relative to the frame.

13. The agricultural disk opener as claimed in claim 9, further including:
linkage connected to the frame and configured to couple the disk opener to an implement.

14. The agricultural disk opener as claimed in claim 13,
said frame and linkage cooperatively defining a parallelogram linkage.

15. The agricultural disk opener as claimed in claim 9,
said anhydrous ammonia injector being pivotably mounted to the frame for movement between forward and rearward positions relative to the direction of travel; and
a biasing element yieldably biasing the anhydrous ammonia injector to the forward position.

16. The agricultural disk opener as claimed in claim 9, further including:
a gauge wheel rotatably mounted to the frame and configured to control a depth of the furrow created by the disk blade.

17. The agricultural disk opener as claimed in claim 1, further including:
a seed boot having one or more internal passages configured to deliver a seed or a treatment into the furrow.

18. The agricultural disk opener as claimed in claim 17,
said seed boot being positioned forward of the injection zone.

19. The agricultural disk opener as claimed in claim 1,
said injection point being approximately centered in the furrow.

20. The agricultural disk opener as claimed in claim 19,
said injection point being positioned forward of the injection zone.

21. The agricultural disk opener as claimed in claim 20,
said anhydrous ammonia injector including a delivery tube in communication with the injection point,
said delivery tube defining the injection point,
said delivery tube being configured to deliver the anhydrous ammonia at a downward and rearward angle into the furrow.
